(19) United States
(12) Patent Application Publication
(10) Pub. No.: US 2003/0224258 A1
(43) Pub. Date: Dec. 4, 2003

(54) Developed electrostatic images produced using reduced density color toners

(76) Inventors: Romit Bhattacharya, Morris Plains, NJ (US); Giovanni Perrotta, Wayne, NJ (US); Charles Edwards, Mountain View, CA (US)

Correspondence Address: PENNIE AND EDMONDS, 1155 AVENUE OF THE AMERICAS, NEW YORK, NY, 100362711

(21) Appl. No.: 10/348,602

(22) Filed: Jan. 21, 2003

Related U.S. Application Data
(63) Continuation of application No. 09/724,677, filed on Nov. 28, 2000, now abandoned.

(51) Int. Cl. G03G 13/01

(52) U.S. Cl. 430/18; 430/45

(57) ABSTRACT

A method of producing a high resolution image on a substrate using an electrostatic printer by providing an electrostatic printer having a plurality of toner fountains and a set of color toners, the set having at least one reduced density toner having a color density less than that of a standard toner of the same color; and applying the reduced density toner in at least two passes of a substrate through the electrostatic printer to develop a desired image for that color. With the method of the invention, at least two toners of the same color, but different color density, may be provided to one toner fountain, thereby allowing the toner fountain to function in the manner of a plurality of toner fountains without requiring a flushing step.

The invention is directed to a method of producing high resolution images on an electrostatic printer having a plurality of toner fountains, where the liquid toners useful in the invention include black (B), reduced density cyan (LC), dark cyan (DC), dark magenta (DM), reduced density magenta (LM), yellow (Y), reduced density yellow (LY), and white (W), and where the set of toners include at least one cyan toner, at least one magenta toner, and at least one yellow toner, where at least one of the toners is a reduced density toner having a color density less than that of a standard toner of the same color.

### BACKGROUND OF THE INVENTION

Use of liquid toners for electrostatography, i.e., the production of a visible, permanent image from a latent image consisting of a pattern of electrostatic charges, is well known. Liquid toners are typically used to develop electrostatic images in imaging systems that incorporate features similar to those of dry toner based copier and printer systems.

However, liquid toner particles are significantly smaller than dry toner particles, i.e., typically less than about 3 micrometers (μm), and are capable of producing toned images having very high resolution. Therefore, liquid toners have a number of advantages over dry toners, including the production of sharper and better defined images, a higher degree of and more delicate gradations of contrast, and cleaner whites. Liquid toners can also provide for a more economical use of the toner, a faster developing cycle, and simpler, less expensive and more trouble-free developing equipment.

Liquid toners are generally used to produce an image by the selective deposition of a pigment on a substrate to form a visible pattern. Although liquid toners are typically used in liquid electrostatic developers for electrostatic printers and copiers, they can also be used in ink-jet printers, as well as equipment for high-speed print-outs and reproductions of microfilms, facsimile printing, and instrument recordings. Images produced with liquid toners include pictures, e.g., half-tone pictures, line pictures, and photographic reproductions, as well as symbols, digits, graphs, and letters, i.e., any image that can be produced on an analog or digital electrostatic copier or printer. In particular, liquid toners are increasingly used to produce signs, posters, and charts for seminars and corporate events and meetings, binder cover inserts, packaging, short-run labels, store window display graphics, and outdoor billboards.

Typically, liquid toners have two phases, a continuous phase of a liquid hydrocarbon solvent system and a dispersed phase of dispersed pigments. The liquid hydrocarbon system has a high electrical resistivity, i.e., greater than 10⁹ ohm·cm. This high resistivity does not allow the electrostatic charges on the substrate, typically a copy sheet or an electrostatic or xeroprinting master, to bleed off before the image is formed, thus maintaining the desired degree of contrast.

The liquid hydrocarbons should evaporate quickly, so that a thin film will evaporate in a few seconds at a temperature below the char point of paper, and should dry fully, so that a liquid-free pigment film is deposited. The liquid hydrocarbon system should be nontoxic when the vapor is inhaled or when the liquid comes in contact with skin, substantially odor free, and physically and chemically inert with respect to the copy sheet. A low viscosity is desirable, since this allows the dispersed phase to migrate through the continuous phase as a result of an attraction to an electrostatically charged substrate, to form an image by coupling with a pattern of electrostatic charges on the substrate. The continuous phase contains dissolved and suspended solids, including pigments, a fixative or fixing agent, typically a thermoplastic resin having the ability to flow under heat to fuse the deposited material to the substrate surface, and increase the bond between the deposited material and the substrate. Dissolved and suspended solids also include a dispersant, typically a long chain organic compound, such as a synthetic polymer, having both oil soluble and polar groups, to aid in the dispersion of suspended particles, and a charge director, typically a metallic derivative of a fatty acid or resin acid. The charge director is absorbed by individual pigment particles, which causes the pigment particles to aggregate in the dispersed phase. The dispersion of the aggregates formed is stabilized by the dispersant by an entropic repulsion mechanism.

The charge director also acts as an ionic surfactant, which forms inverse micelles in low dielectric media, such as the liquid hydrocarbon solvent system, and produces an electrostatic charge on particles dispersed in the continuous phase. Although a number of mechanisms are believed to be involved in the spontaneous separation of charges between the dispersed particles and the micelles, the acid-base chemistry of the dispersed particles and the ionic surfactant micelles is believed to play a major role in the production of charged particles, so that a proton or cation exchange from the particles to the micelles occurs when negatively charged particles are produced, and from the micelles to the particles when positively charged particles are produced. In addition, an electrode may be used to induce an electrostatic charge in the toner particles prior to their application to a substrate. The charge on the particles can be selected by the appropriate choice of charge director.

Electrographic and electrophotographic processes are well known, and are described by Steven P. Schmidt et al., Handbook of Imaging Materials, Chap. 6, 227-252 (1991). There are the numerous variations of these processes, all of which incorporate the same basic steps of creating an electrostatic image on a substrate, developing the image with charged, colored particles, i.e., toner, optionally transferring the resulting developed image to a secondary substrate, and fixing the image to the substrate.

The first basic step, once an image has been stored, typically, in a digital format on a computer, is the creation of an electrostatic image, which can be accomplished by a variety of methods. In the electrophotographic process, the electrostatic image is formed by a discharge of a uniformly charged photoconductor. The discharge occurs when the uniformly charged photoconductor is exposed to light, which may be reflected from or transmitted through an image that is being copied, or be provided by a laser in a digital laser copier or printer. The exposure may be analog or digital, and the photoconductor may be single use or rechargeable and reimageable. Single use devices may be repeatedly charged and developed after a single exposure, but are permanently imaged by the exposure. With both the single use and rechargeable devices, the electrostatic image is created by corona charging a photoconductor, followed by image wise exposure and photodischarge. The electrostatic image is then developed with liquid toner having either positively or negatively charged particles, and transferred electrostatically to plain paper. The photoconductor may then be cleaned, charged, and reimaged.

In one form of the electrostatic process, a photosensitive element is permanently imaged to form areas of differential conductivity. The electrostatic image is created by uniform electrostatic charging followed by differential discharge of the imaged element. The electrographic or xeroprinting elements or masters can be repeatedly charged and developed after a single imaging exposure.

In an alternative electrographic process, electrostatic images are created ionographically. The latent image is created on a dielectric medium, such as paper or film, which is capable of holding a charge, by applying a voltage to one or more members of an array of electronic writing styluses or nibs. The styluses or nibs are selected in a manner that will produce the desired image when ions are produced from the applied voltage, placing a charge, and forming the latent image on the dielectric medium.

However the electrostatic image is produced, the image is developed with toner particles that possess a charge opposite to that of the charged surface to which they are applied. With liquid toners, a flowing liquid ensures the availability of sufficient toner particles to develop the image. When the flowing liquid is brought into direct contact with the electrostatic image, the charge of the electrostatic image creates a field that causes the charged toner particles to move through the nonconductive continuous phase by electrophoresis. As the charged toner particles contact the latent electrostatic image, the charge of the image is neutralized by the oppositely charged toner particles, and a layer of pigment is deposited, forming a permanent image.

If a reimageable photoreceptor or an electrographic master is used, the developed image must be transferred to paper or other substrate. To transfer the image, the substrate is charged electrostatically with the polarity chosen to cause the toner particles to transfer to the substrate. The substrate is then brought in contact with the reimageable photoreceptor or an electrographic master to produce the final image on the desired substrate.

Finally, the toned image must be fixed to the substrate. For self-fixing toners, residual solvent is removed from the substrate by air-drying or heating. The evaporation of the solvent results in a toner film that is bonded to the paper. For heat fusible toners, thermoplastic polymers are incorporated in the toner particles. Heating removes any residual solvent and fixes the toner to the substrate.

For color images, in prior art printing methods, four different liquid toners having different colored pigments are used individually in four separate passes through the developer. Color printers typically have four separate sources of toner, which are typically referred to as toner fountains, one for each of the colored toners, i.e., one for black and one for each of the primary colors used in color developing: magenta, cyan, and yellow. However, there are commercially available printers that include a fifth fountain for an additional toner. On each pass of the substrate through the developer, the latent image is formed in a manner such that only that part of the image that is of a particular color is deposited on any given pass. After the fourth pass, the four toners form a full color image.

Prior art four-color electrostatic printing is described in U.S. Pat. No. 5,899,604 to Clark (“the '604 patent”), the contents of which are incorporated herein in their entirety by reference. A typical four-color electrostatic print is typically formed as follows: The image to be printed is first created in digital form as a series of dots, either directly on a computer, or an existing image is scanned and stored in a computer. A Raster Image Processing Program (“RIP”) is then used to convert the image from the red, green, blue format to the cyan, magenta, yellow, black format, and to separate the digitized image into color planes, i.e., the cyan, magenta, yellow, and black portions of the image, which are then printed separately, one over the other, to form the final image. As the pigments or dyes in the toner are transparent/translucent, and overlay one-another and absorb, rather than emit, light, the image is said to be a “subtractive” color image. Typically, electrographic printers print the image in raster fashion, such that each color plane image is printed in raster lines of one color at a time, starting at one end of the image and finishing at the other end, in well-known fashion, overlaying the second color over the first, the third over the first and second, and, finally, the fourth over the first, second, and third.

The '604 patent also teaches printing with seven or eight colors, but is only enabling for ink jet printers. Moreover, although the '604 patent teaches the use of seven or eight toners, where three or four of the toners used are each the same color as that of one of the other toners, the '604 patent teaches that each toner is applied only once in the formation of an image.

Because each toner is only applied once in prior art printing methods, light colors are difficult to obtain. Typically, a light portion of an image is formed by only printing a fraction of the total number of dots that are possible. As a result, the substrate shows through the pattern of dots giving a light color to the image. However, on close inspection of the image, the separation of the dots becomes apparent, and the image appears grainy.

Recently, manufacturers of electrostatic printers such as RasterGraphics (Orchard Parkway, San Jose, Calif.) and 3M (St. Paul, Minn.) have introduced 54 inch wide printers with 5 inking fountains. The initial purpose for the additional fountain was to utilize “Spot Color” toners (i.e. toners with a specific color to achieve an exact solid color without the need for half toning or “dithered dots”), “Neon”, or “Fluorescent” toners. The additional fountain can also be used to apply a protective overcoat on the electrostatic print by applying a “digital varnish”, as described in U.S. Pat. No. 5,744,269 to Bhattacharya et al., the contents of which are incorporated herein in their entirety by reference.

Large format electrostatic printing has evolved over the past 12 years with applications ranging from Point-of-Purchase displays, signs and banners, trade show graphics, outdoor billboards, fleet graphics, bus shelters, wall paper, vinyl flooring, and backlit displays to name a few. These prints are produced by using pigment based color liquid toners. Over the past three years, new toners incorporating dispersed sublimable dyes have dramatically increased the applications for electrostatic printing. By imaging first on electrostatic paper and then applying heat, pressure and time, these images can be transferred onto a wide variety of other substrates, including, but not limited to a wide variety of polyester fabrics, MYLAR®, and TYVEK®. However, at present, a dye for a white sublimation toner is not available. By applying a coating of polyester, polyurethane or acrylic resin, these images formed with sublimation toners can also be transferred to, for example, wood, metal, plastic, glass, porcelain, ceramic tiles, stone, PLEXIGLAS®, concrete board, high pressure and low pressure laminate, and CORIAN®, to name just a few materials.

While the dye sublimation process has allowed a greater range of applications, the image quality inherent in 4-color electrostatic printing with its grainy dots and color gradations and inability to produce acceptable midtones has prevented acceptance of such prints in various markets where close viewing is a requirement. Those markets include, but are not nearly limited to, apparel printing, decorative ceramic tiles, home furnishing and upholstery, wall coverings, and fine art reproduction.

As discussed above, four-color electrostatic printing methods are known in the art. For example, U.S. Pat. No. 4,181,423 to Pressman et al. discloses a method and an apparatus for modulated aperture electrostatic half tone printing using modulated ion streams and transparent toners. Color images are formed by overlaying black, magenta, cyan, and yellow images to form a full color image, where additional colors, such as metallics, may be added for special effects.

U.S. Pat. No. 4,777,576 to Fur et al. discloses a method and an apparatus for pattern generation on a dielectric substrate to produce a full color image from four process colors. A five color unit may be used to apply silver, gold, magnetic, or other special-purpose ink or coating.

U.S. Pat. No. 5,749,032 to Landa et al. discloses a color imaging system in which separate yellow, magenta, cyan, and black liquid toners are supplied from four different reservoirs.

U.S. Pat. No. 5,953,566 to Fujiwara et al. discloses an electrographic color image forming method and apparatus in which a plurality of liquid developing devices accommodating liquid developer comprising colored microparticles dispersed in an electrically insulated fluid medium are used to form toner images of different colors, i.e., cyan, yellow, magenta, and black, which are electrostatically transferred and overlaid to produce an overlaid toner image on a substrate.

At present, electrostatic printers form images from dots that are all of substantially the same size, where the dot size is fixed by the printer design. Therefore, to improve the image resolution using prior art methods requires a major redesign of the printer, which must be modified or replaced to obtain a smaller dot size, e.g., a decrease in dot size that allows an increase from 200 dots per inch (“dpi”) to 300 dpi.

Therefore, a need exists for a method of multi-color electrostatic printing that overcomes the prior art deficiencies in image quality, which produces a smooth, non-grainy image, and allows the highly efficient electrostatic digital printing process to enter a much wider variety of markets without the need for new printers with a smaller dot size. The present invention provides such a method.

### SUMMARY OF THE INVENTION

In a first embodiment, the present invention is directed to method of producing a high resolution image on a substrate using an electrostatic printer, as well as to developed electrostatic images formed with the method of the method of the invention. The method of the invention comprises providing an electrostatic printer having a plurality of toner fountains and a set of color toners, the set comprising at least one reduced density toner having a color density less than that of a standard toner of the same color, and applying the reduced density toner in at least two passes of a substrate through the electrostatic printer to develop a desired image for that color to provide an image having a significantly improved resolution and sharpness. Typically, a different portion of the desired image is formed with each application of the reduced density toner.

In one preferred embodiment, the method of the invention further comprises creating a digital image that corresponds to a final image to be printed on the substrate; separating the image into separate color planes, wherein each color plane corresponds to that portion of the final image that is applied to the substrate with a specific toner; separating each color plane that corresponds to a reduced density toner into at least two additional color planes, wherein each additional color plane corresponds to a different level of color in the final image; forming an electrostatic image comprising a pattern of dots on the substrate that corresponds to one of a color plane or an additional color plane; and developing the electrostatic image with the appropriate color toner. The substrate makes a separate pass through the electrostatic printer for each of the color planes, so that the steps of forming each electrostatic image and developing the image are repeated for each color plane, including the additional color planes for the reduced density toners. Preferably, the reduced density toner is applied to the substrate in at least two passes of the substrate through the electrostatic printer, such that each application creates incrementally darker dots by applying dots of reduced density toner one on top of the other. In addition, the digital image is preferably created on a computer, either directly by the action of a computer operator or by scanning and digitizing a preexisting image, and is separated into the color planes with a raster image processing program.

In a further preferred embodiment, the method of the invention further comprises creating a digital image that corresponds to a final image to be printed on the substrate; separating the image into separate color planes, wherein each color plane is different, and corresponds to at least a portion of that portion of the final image that is applied to the substrate with a specific toner in a single pass of the substrate through the electrostatic printer; forming an electrostatic image on the substrate that corresponds to one of the color planes, and developing the electrostatic image with the appropriate color toner. The substrate makes a separate pass through the electrostatic printer for each of the color planes, so that the steps of forming each electrostatic image and developing the image are repeated for each color plane. To form a portion of the final image having a color density that is greater than that obtainable with a single application pass of the reduced density toner, the reduced density toner is applied to that portion of the image in multiple application passes. Preferably, the digital image is again created on a computer, either directly by the action of a computer operator or by scanning and digitizing a preexisting image, and is separated into the color planes with a raster image processing program.

Therefore, each of the reduced density toners is applied in a plurality of incremental passes. As a result, dots of different color densities and, thus, developed electrostatic image having color densities that vary for each of the colors corresponding to the reduced density toners may be formed. Where a single dot in the image is formed by the application of a reduced density toner in a single pass, the dot will have the lowest color density possible with that toner. The application of the same reduced density toner to the same dot in a second pass will result in a dot having a color density of about twice that obtained in a single pass. Additional passes can then be used to obtain dots having the desired color density, although two passes is typically sufficient. As the reduced density toner applied in each pass has a color density that is less than that of a standard density toner, more dots can be printed for a given color density on a single pass. That is, because the color density of a reduced density toner is lower than that of a conventional toner of the same color, more dots are require with the reduced density toner to obtain a color image of the same color density than are require with the conventional toner. This increase the resolution and decreases the graininess of the final image.

In contrast, with prior art printing methods, the theoretical maximum resolution obtainable with a printer is not possible for lighter shades of color in an image, as the number of dots printed must be reduced from the maximum to allow a portion of the substrate to show through the color, lightening the image. However, this results in a grainy image, as reducing the number of dots results in an increased spacing between the dots. This reduction in the number of dots is avoided in the present invention, as the use of a lighter toner allows more dots to be printed for a given shade of color, resulting in an image having less grain and higher resolution.

Moreover, in addition to creating color planes for the application of each color toner, the raster image processing program can be used to improve resolution of the final image by creating a series of different planes of color information for the application of each reduced density toner. As a result, rather than overlaying applications of the same reduced density toner on the same dot to obtain variations in color density, the raster image processing program can create electrostatic images that have different arrangements of dots. By varying the arrangement of dots for each application of the reduced density toner, more subtle gradations of color are obtained, as the number of dots used to produce a particular color can be increased, decreasing the distance between dots, and, thus, reducing the graininess of the final image. Dots may also be overlapped or overlaid to obtain improved color gradation.

Typically, set of toners used comprises at least one cyan toner, at least one magenta toner, and at least one yellow toner. Preferred toners include the set comprising black, reduced density cyan, dark magenta, and yellow; the set comprising black, dark cyan, reduced density magenta, and yellow; the set comprising black, reduced density cyan, reduced density magenta, and yellow; the set comprising black, reduced density cyan, reduced density magenta, dark magenta, and yellow, the set comprising black, reduced density cyan, dark cyan, reduced density magenta, and yellow; the set comprising black, reduced density cyan, reduced density magenta, yellow, and a spot color; the set comprising black, reduced density cyan, dark cyan, reduced density magenta, dark magenta, and yellow; the set comprising black, reduced density cyan, reduced density magenta, dark magenta, yellow, and a spot color; set comprising black, reduced density cyan, dark cyan, reduced density magenta, yellow, and a spot color; the set comprising black, reduced density cyan, dark cyan, reduced density magenta, yellow, and reduced density yellow; and the set comprising black, reduced density cyan, reduced density magenta, dark magenta, yellow, and reduced density yellow.

In a further embodiment, the present invention is directed to method of producing a high resolution image on an electrostatic printer, where the method comprises providing an electrostatic printer having a plurality of toner fountains and a set of liquid toners, where the set is selected from the group consisting of the set comprising black, reduced density cyan, dark magenta, and yellow; the set comprising black, dark cyan, reduced density magenta, and yellow; the set comprising black, reduced density cyan, reduced density magenta, and yellow; the set comprising black, reduced density cyan, reduced density magenta, dark magenta, and yellow, the set comprising black, reduced density cyan, dark cyan, reduced density magenta, and yellow; the set comprising black, reduced density cyan, reduced density magenta, yellow, and a spot color; the set comprising black, dark cyan, dark magenta, yellow, and white; the set comprising black, reduced density cyan, dark cyan, reduced density magenta, dark magenta, and yellow; the set comprising black, reduced density cyan, reduced density magenta, dark magenta, yellow, and a spot color; the set comprising black, reduced density cyan, dark cyan, reduced density magenta, yellow, and a spot color; the set comprising black, reduced density cyan, dark cyan, reduced density magenta, yellow, and reduced density yellow; and the set comprising black, reduced density cyan, reduced density magenta, dark magenta, yellow, and reduced density yellow. An electrostatic image is then formed on a substrate that corresponds to at least a portion of that portion of a final image that is formed from one of the toner colors, and is developed with the appropriate color toner. The final image is formed by the steps of forming the electrostatic image and developing the image for each color toner, where any of the reduced density toners and the white toner are applied in at least two passes of a substrate through the electrostatic printer to develop the image for that color.

In yet a further embodiment, the invention is directed to a method of producing a high resolution image on a substrate using an electrostatic printer, where the method comprises providing an electrostatic printer having a plurality of toner fountains and a set of liquid color toners. The set of toners comprises at least one cyan toner, at least one magenta toner, and at least one yellow toner, where at least one of the toners in the set is a reduced density toner having a color density less than that of a standard toner of the same color. That is, to obtain a final image having a color density equivalent to that obtained with a single pass of the substrate through the electrostatic printer to apply the standard toner, the reduced density toner must be applied in at least two passes of the substrate through the printer. A digital image is created that corresponds to a final image to be printed on a substrate, and separated into separate color planes, where each color plane is different, and corresponds to at least a portion of that portion of the final image that is applied to the substrate with a specific toner in a single pass of the substrate through the electrostatic printer. An electrostatic image is then formed on the substrate that corresponds to one of the color planes, and is developed with the appropriate color toner. Each color is further specified in color planes at each desired color level, corresponding to a single pass for the lightest color level desired, two passes for a darker color, and so on, until the desired color density is achieved. As each pass with a reduced density toner is used to develop an electrostatic image that differs from that of other passes with the same reduced density toner, the coverage, resolution, and sharpness of the final image is significantly improved over that of images formed with prior art electrostatic printing methods. The steps of forming and developing the electrostatic image are then repeated at least once for each color toner to form the final image, where the reduced density toner is applied in at least two passes through the electrostatic printer to develop a desired image for that color.

Using the method of the invention, a developed electrostatic image is formed on a substrate, where the image comprises at least two layers of at least one reduced density toner having a color density less than that of a standard toner of the same color or a white toner.

### BRIEF DESCRIPTION OF THE DRAWINGS

FIG. 1 illustrates the application of a toner by the method of the invention, using an electrophotographic printer.

FIG. 2 illustrates the application of a toner by the method of the invention ionographically.

FIG. 3 illustrates a cross section the transfer of an electrostatic image, formed from dye sublimation toners, from a first substrate to a second substrate.

### DETAILED DESCRIPTION OF THE INVENTION

As used herein, the terms “electrostatic image” and “electrostatic print” refer to any image, picture, half-tone picture, line picture, photographic reproduction, symbol, digit, graph, letter, sign, poster, chart, binder cover insert, packaging, short-run label, store window display graphic, outdoor billboard, or any other type of image produced with any electrostatic method, including electrostatography, electrostatic developers, xeroprinting, xerography, and any other electrographic or electrophotographic method.

Also, as used herein, reference to reduced density cyan (LC), reduced density magenta (LM), and reduced density yellow (LY) toners refers to toners having those colors and a color density that is less than that of toners used in prior art four color electrostatic printing. Preferably, the color density is no more than 50 percent of that of toners used in prior art four color electrostatic printing. Reference to dark cyan (DC), dark magenta (DM), and yellow (Y) toners indicates toners having substantially the same color density as that of toners used in prior art four color electrostatic printing.

The invention is directed to developed high resolution electrostatic images and to a method of producing high resolution images on a substrate using an electrostatic printer having a plurality of liquid toner fountains, typically, at least four, a raster image processing program (“RIP”), such as that available from Onyx Graphics (Salt Lake, Utah), and at least four specifically designed liquid color toners, such as those available from Specialty Toner Corporation (Fairfield, N.J.). By the combined use of the relevant software and uniquely formulated toners, the color process of the invention produces an electrostatic print with a dramatically higher dynamic range, wider color gamut, and clearer, more detailed appearance than is achievable with prior art four-color electrostatic printing. In particular, the application of one or more reduced density toners in multiple passes to develop electrostatic images for different color planes provides the unexpected improvement in image quality by reducing dot spacing in the image, and allowing for greater gradations in color density.

In the method of the invention, each toner fountain is used to apply at least one toner in a set of toners having the colors required to produce the image. Typically, the set of toners comprises at least one cyan toner, at least one magenta toner, and at least one yellow toner, where at least one of the toners in the set has a color density that is less than that of a standard toner of the same color. Liquid toners useful in the invention include black (B), cyan (C), reduced density cyan (LC), dark cyan (DC), magenta (M), dark magenta (DM), reduced density magenta (LM), yellow (Y), reduced density yellow (LY), and white (W).

Preferred sets of toner colors include (1) black, reduced density cyan, dark magenta, and yellow; (2) black, dark cyan, reduced density magenta, and yellow; and (3) black, reduced density cyan, reduced density magenta, and yellow for printers with four toner fountains; (4) black, reduced density cyan, reduced density magenta, dark magenta, and yellow, (5) black, reduced density cyan, dark cyan, reduced density magenta, and yellow; (6) black, reduced density cyan, reduced density magenta, yellow, and a spot color; and (7) black, dark cyan, dark magenta, yellow, and white for printers having five toner fountains; and, for printers having six toner fountains, (8) black, reduced density cyan, dark cyan, reduced density magenta, dark magenta, and yellow; (9) black, reduced density cyan, reduced density magenta, dark magenta, yellow, and a spot color; (10) black, reduced density cyan, dark cyan, reduced density magenta, yellow, and a spot color; (11) black, reduced density cyan, dark cyan, reduced density magenta, yellow, and reduced density yellow; and (12) black, reduced density cyan, reduced density magenta, dark magenta, yellow, and reduced density yellow.

As will be readily understood by those skilled in the art, other sets of toners will be useful with the present invention, in particular, where additional toner fountains are available. In addition, it will also be apparent to those skilled in the art that the present invention is not limited by the present availability of printers only having four or five toner fountains, as the design and assembly of multiple-fountain printers of the type presently available commercially, but having more than five toner fountains is within the present state-of-the-art.

Presently, as currently available electrostatic printers have a maximum of five toning stations, the electrostatic printing process of the invention utilizes four or five color toner fountains. However, the process of the invention can be applied to printing with more than five colors as printers having additional printer fountains become available, or by utilizing two or more toner reservoirs to supply toner to the fountain, as described below. As appropriate printers become available, the concept behind the printing method of the invention and the design of the appropriate liquid toners can be extended to take advantage of electrostatic printers with more than five toning stations. Prior to the present invention, electrostatic printing provided higher productivity (6-25 times faster) than Inkjet devices, but lacked the print quality provided by ink jet printers capable of providing six or more colors.

As discussed above, electrostatic printers form images from dots that are all of substantially the same size, where the dot size is fixed by the printer design. Therefore, to improve the image resolution using prior art methods requires a major redesign of the printer, which-must be modified or replaced to obtain a smaller dot size, e.g., a decrease in dot size that allows an increase from 200 dots per inch (“dpi”) to 300 dpi. However, it has been unexpectedly discovered that the image resolution of current electrostatic printers can be improved by about 200 to 400 percent using the novel toners and methods of the present invention. As discussed above, the method of the invention provides reduced dot spacing to improve image resolution.

Resolution is improved using multi-layer dots through sequential layering.

In this method, at least one of the standard electrostatic printer toners, which are transparent and/or translucent, is replaced with toners of the same color at a reduced density. For example a standard cyan toner may be replaced with a specialized cyan toner having a color density of only one-third of that of the standard cyan toner. The reduced density toners are formulated so that successive layers of toner can be printed, one upon the other, to build up the color density, thereby producing a solid color.

A typical raster image processing program or RIP works in the manner described in U.S. Pat. No. 5,899,604. In the present invention, a RIP, preferably the RIP available from Onyx, is utilized with at least four customized color toners, such as those available from Specialty Toner Corporation, to achieve an extended dynamic color range in the print output. In order for the process to work properly, several components and conditions must be optimized and interconnected. The RIP used in the printing process identifies and applies each layer of the color at a different color density level, which separates the image by color into different levels. As a result, images of a given color having different color densities can be formed. For example, using a cyan toner having a color density one third of that of a standard cyan toner allows portions of the image to be formed having at least three different cyan densities, i.e., one-third, two-thirds, and full cyan levels. Darker colors can be formed by applying additional layers of color.

As will be readily understood by one of ordinary skill in the art, toners useful in the invention may have any color density that is less than or equal to that of a standard toner, and may be of any useful color. However, at least one toner used to form an image with the method of the invention has a color density may range from about 1 percent to about 99 percent of that of a standard toner. Preferably, at least one toner has a color density of from about 5 percent to about 50 percent of the color density of a standard toner of the same color, with 5, 10, 20, 25, 33_{1/3}, and 50 percent being most useful, requiring 20, 10, 5, 4, 3, and 2 passes, respectively, to obtain 100 percent color density. However, it should be noted that application of an amount of reduced density toner sufficient to provide the color density of a standard toner is not required, so that a greater variation in color tone may be obtained.

The toners are formulated and balanced to provided the appropriate combination of two or more colors required to produce any given secondary color. For example, for dark cyan, dark magenta, reduced density cyan, reduced density magenta, and yellow, a combination of reduced density cyan, dark cyan, and yellow gives green, a combination of reduced density magenta, dark magenta, and yellow gives red, and a combination of reduced density cyan, dark cyan, reduced density magenta, and dark magenta gives blue or purple, where a desired shade of each color is obtained varying the relative amounts of each toner. Similarly, the appropriate combination of all five colors produces either a gray or black depending on the percentage of each color use.

The addition of a white toner can be used to create the required gray scale, and achieve the color gamut that would otherwise be provided by the reduced density cyan and reduced density magenta. Thus, grey is obtained from a combination of black and white toners, green is obtained from a combination of white, cyan, and yellow toners, red is obtained from a combination of white, magenta, and yellow toners, and blue and purple are obtained from a combination of white, cyan, and magenta toners. In order to achieve the required color balance using any of the combinations of toners described above, a specific reflective print density must be produced on the paper, film, vinyl, polyester cloth or the other medium or substrate on which electrostatic prints can be applied to produce the final print.

The reflective print density range for each reflective color toner typically used in the present invention, as measured on an X-Rite 404 Reflective Densitometer, typically falls within the following ranges: for black, about 1 to about 1.55, for a normal cyan, about 0.9 to about 1.35, for reduced density cyan, about 0.6 to about 0.9, dark cyan, from about 1.10 to about 1.40, for a normal magenta, about 1 to about 1.45, for a reduced density magenta, about 0.6 to about 0.9, for a dark magenta, from about 1.10 to about 1.40, for a normal yellow, from about 0.65 to about 0.85, and for a reduced density yellow, from about 0.3 to about 0.55. A white toner, using the paper as a reference, typically has a AE of about ±5 relative to the paper.

For dye sublimation toners, reflective print densities on paper, as measured on an X-Rite 404 Reflective Densitometer, prior to image transfer are as follows: for black, about 0.9 to about 1.25, for a normal cyan, about 0.65 to about 1.2, for reduced density cyan, about 0.4 to about 0.65, for dark cyan, from about 0.9 to about 1.2, for a normal magenta, about 0.9 to about 1.25, for a reduced density magenta, about 0.35 to about 0.65, for a dark magenta, from about 0.95 to about 1.35, for a normal yellow, from about 0.35 to about 0.65, and for a reduced density yellow, from about 0.2 to about 0.4. At present, a white dye sublimation toner is not available. However, it is believed that a white dye sublimation toner will eventually be developed for use with the present invention.

Formulations for electrostatic liquid color toners are well known in the art. For the printing process of the invention, however, it is necessary to formulate toners that differ from prior art toners to provide the different variations of cyan, magenta, and yellow in order to achieve the desired results. Reduced density cyan, magenta, and yellow can be prepared in several ways, including: diluting standard cyan, magenta, and yellow toners, decreasing the pigment content in the appropriate formulation, or modifying the charge per particle, i.e., the charge/mass ratio, so that fewer charged color pigment/dispersed dye particles are attracted to the opposite latent charge on the electrostatic paper during development of an electrostatic image to yield a lower saturation of cyan and magenta, i.e., “lighter” cyan, magenta, and yellow.

Similarly, dark cyan and magenta can be produced by taking the opposite route such as: increasing the concentration of the toner, increasing the pigment content in the formulation, or modifying the charge, so that more particles are attracted to the electrostatic image during development to yield a higher saturation of cyan and magenta, i.e., “darker” cyan and magenta.

As noted above, electrostatic printers having more than five toner fountains are not presently available commercially, although they are within the present state-of-the art. That is, the theory and technology required to construct a printer having more than five toner fountains is known. In addition, it has been discovered that it is possible to modify existing printers at minimal cost to allow the use of more than five toners.

In prior art printers and printing methods, four or five different color toners are used, and each color toner is applied by a separate fountain. If additional toners are required with the prior art, at least one fountain must be flushed to prevent contamination of the colors, as each toner used in the prior art is of a completely different color, and residual toner fluid remains in a fountain after use. Therefore, using different color toners in the same fountain has been avoided to prevent color contamination.

In contrast, with the present invention, multi-layer dots and sequential layering may be achieved using multiple toners of the same color, but a different color density, in each electrostatic fountain. As the specialized toners used in the invention are of the same color, the toners are compatible with one another, and, thus, there is no contamination. The difference in the multi-level toners, i.e., toners having different color densities, is simply the color density of the toner, which is not effected to any significant degree by the change in toner supplied to the fountain. Therefore, no flushing of the fountain is required to prevent contamination.

In this regard, the simplest printing system useful in the invention is one utilizing a two level fountain; e.g., a single fountain fed by two reservoirs, one containing a toner having, for example, a color density of about 50 percent and the second toner having a color density of about 100 percent. However, any fountain can be fed by three or more toner reservoirs, where the number is only limited by space consideration, so that no additional fountains are required, and, thus, only minor modifications to the printer, such as the incorporation of additional toner reservoirs and valves to allow the change over from one toner to the other.

The application of multi-layers using the method of the invention can be used with any number of colors and any number of layers in the printing process, and may also be used with single level application. For example, a single level yellow and/or black may be used with multi-level magenta and cyan. As the multi-level process requires additional passes of the substrate through the printer, more time is required for the additional passes. Therefore, it may be more productive to limit the multi-layer process to the more visible colors, magenta and cyan, and perform only a single pass for yellow and black. However, the use of multi-level yellow and/or black is also within the scope of the present invention.

The present invention represents a significant enhancement over that of the five color printing method disclosed in co-pending application Ser. No. 09/XXX,XXX, filed Jan. 13, 2000, entitled METHOD FOR PRODUCING DEVELOPED ELECTROSTATIC IMAGES USING MULTIPLE TONER FOUNTAINS, the contents of which are incorporated herein by reference to the extent necessary to supplement this specification. In particular, the present invention allows the use of a black toner to provide a true black in the resulting image.

Printing with the method of the invention using four toners may be accomplished as follows: For black, reduced density cyan, dark magenta, and yellow, the reduced density cyan is printed a sufficient number of times to provide the color density desired, such as that obtained with a dark cyan. Similarly, using black, dark cyan, reduced density magenta, and yellow, the reduced density magenta toner is printed in successive layers until the desired color is obtained. Multiple toning of both reduced density magenta and reduced density cyan is used when the toner set is black, reduced density cyan, reduced density magenta, and yellow.

Similar logic follows for 5 and 6 toner systems described above, where each of the reduced density cyan, reduced density magenta, and reduced density yellow are applied through sequential layering to provide the full color gamut. In addition, the invention allows the use of one fountain, typically the fifth fountain in a five fountain printer, to be used for a white toner, which, when used with black, provides gray, or spot or fluorescent color, or DIGITAL VARNISH®, available from Specialty Toner Corporation, Fairfield, N.J., as disclosed in U.S. Pat. No. 5,744,269. In addition, the use of a true black, allows the production of images having truer, more vibrant colors, and requires less operator maintenance than is required otherwise to produce a true black.

Except for those sets of toners utilizing a white toner, which is only available as a reflective toner, each set of toners described above may be used with either reflective or dye sublimation toners. The custom RIP required may be obtained from Onyx Graphics.

The output from the toners is linked with the RIP by building and incorporating specific color profiles and a linearization model that allows parity between the image on a RGB monitor and the 5-color electrostatic printer. In addition, as is well known in the art, that external conditions such as relative humidity and temperature must be maintained within a tight range (45-55% RH, 68-74° F.) in order to achieve optimum results from electrostatic printing. Similar restraints apply in developing photographs.

The multi-color electrostatic printing method of the invention may be used with pigment based color liquid toners and with dispersed sublimable dyes. As a result, the invention can be used to produce large format applications, such as point-of-purchase displays, signs and banners, trade show graphics, outdoor billboards, fleet graphics, bus shelters, wall paper, vinyl flooring, and backlit displays, as well as producing images that can be transferred onto a wide variety of other substrates, including, but not limited to a wide variety of polyester fabrics, MYLAR®, and TYVEK® by imaging first on electrostatic paper and then applying heat, pressure and time. In addition, by applying a coating of polyester, polyurethane or acrylic resin, images formed with sublimation toners can also be transferred to, for example, wood, metal, plastic, glass, porcelain, ceramic tiles, stone, PLEXIGLAS®, concrete board, high pressure and low pressure laminate, and CORIAN®, to name just a few materials. As a result, the present invention is useful in apparel printing, decorative ceramic tiles, home furnishing and upholstery, wall coverings, and fine art reproduction. The multi-color printing of the invention overcomes the deficiencies in image quality of the prior art, and allows the highly efficient electrostatic digital printing process to enter a much wider variety of markets. Morever, because the multi-color printing process of the invention produces a smooth, non-grainy image, small format images, such as, e.g., eight inch by ten inch prints, can also be produced with a highly acceptable image quality.

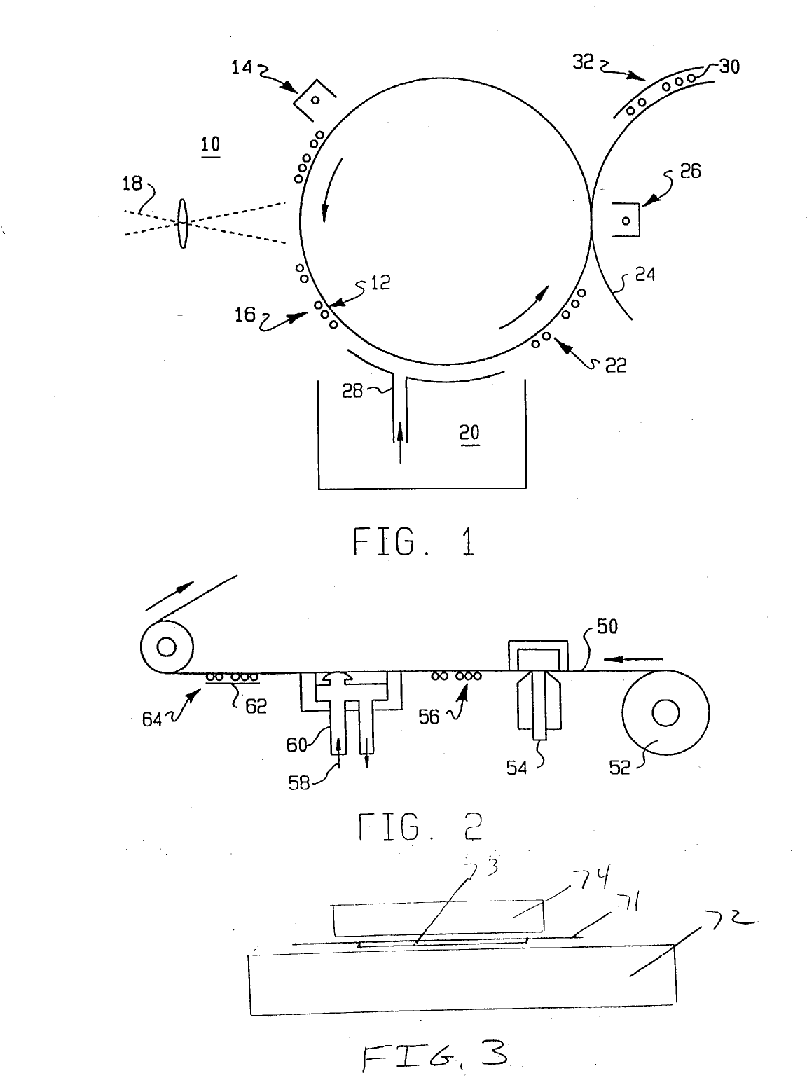

The developed color electrostatic image may be formed on an electrostatic printer using printers and methods well known in the art. FIG. 1 illustrates an electrophotographic device 10 in which photoconductor 12 is uniformly charged by charging source 14. An electrostatic image 16 corresponding to one color in the final image is formed by an analog or digital imagwise photodischarge of charge photoconductor 12. In an analog discharge, the light 18 used to cause the photodischarge is typically reflected from or transmitted through an image being copied. For a digital discharge, the light source is typically a laser, which may be used to digitally scan an image to produce a copy, or may be controlled by a computer to produce a computer created digital image. In either case, the electrostatic image 16 is developed by contacting the image 16 with liquid toner 20 from toner fountain 28, containing a pigment corresponding to the color in the final image. The toned image 22 is then transferred to a substrate 24, such as paper or film, by applying a charge to the substrate from charging source 26. The toned image is attracted to the charge on substrate 24, and forms a final electrostatic image 30. To produce the full color image, one pass through the electrostatic device 10 is required for each toner, as on each pass only that part of the image that corresponds to a specific color is formed. The image is developed with the appropriately colored toner 20 and transferred to substrate 24.

FIG. 2 illustrates an alternative electrographic process, in which an electrostatic image is produced ionographically on a dielectric substrate, e.g., paper or film. Dielectric substrate 50 from dielectric substrate source 52 receives an electrostatic charge from an array of electrostatic writing style or nibs 54, creating electrostatic image 56. As in FIG. 1, the electrostatic image is developed by contact with a liquid toner 58 of the appropriate color from fountain 60 to form a toned image 62.

FIG. 3 illustrates the use of dye sublimation toners, where a mirror image of the final image is first formed on a first substrate, such as paper, with dye sublimation toners, as shown in FIGS. 1 and 2, and then transferred to a second substrate, such as polyester fabrics, MYLAR®, and TYVEK®. However, at present, a dye for a white sublimation toner is not available. By applying a coating of polyester, polyurethane or acrylic resin, these images formed with sublimation toners can also be transferred to, for example, wood, metal, plastic, glass, porcelain, ceramic tiles, stone, PLEXIGLAS®, concrete board, high pressure and low pressure laminate, CORIAN®, etc., by the application of heat. In particular, as shown in FIG. 3, first substrate 71 is placed in contact with second substrate 72, such that mirror image 73 is in contact with second substrate 72. Heat source 74 is then placed in thermal contact with first substrate 71, causing the dye sublimation toners of mirror image 73 to sublime, such that mirror image 73 is transferred to second substrate 72 to form the final image on second substrate 72.

While it is apparent that the invention disclosed herein is well calculated to fulfill the objects stated above, it will be appreciated that numerous modifications and embodiments may be devised by those skilled in the art. Therefore, it is intended that the to appended claims cover all such modifications and embodiments that fall within the true spirit and scope of the present invention.

What is claimed is:

1. A method of producing a high resolution image on a substrate using an electrostatic printer, the method comprising:
providing an electrostatic printer having a plurality of toner fountains and a set of color toners, the set comprising at least one reduced density toner having a color density less than that of a standard toner of the same color; and
applying the reduced density toner in at least two passes of a substrate through the electrostatic printer to develop a desired image for that color.

2. The method of claim 1, further comprising developing a different portion of the desired image with each application of the reduced density toner.

3. The method of claim 1, further comprising:
(a) creating a digital image that corresponds to a final image to be printed on the substrate;
(b) separating the image into separate color planes, wherein each color plane is different, and corresponds to at least a portion of that portion of the final image that is applied to the substrate with a specific toner in a single pass of the substrate through the electrostatic printer;
(c) forming an electrostatic image on the substrate that corresponds to one of the color-planes,
(d) developing the electrostatic image with the appropriate color toner; and
(e) repeating (c) and (d) for each of the color planes to form the final image.

4. The method of claim 3, further comprising forming a portion of the final image having a color density that is greater than that obtained with a single application pass of the reduced density toner by applying the reduced density toner to that portion of the image in multiple application passes.

5. The method of claim 3, further comprising creating the digital image on a computer.

6. The method of claim 5, further comprising creating the digital image scanning an image with a digital scanner.

7. The method of claim 3, further comprising separating the image into the color planes with a raster image processing program.

8. The method of claim 1, further comprising:
(a) creating a digital image that corresponds to a final image to be printed on the substrate;
(b) separating the image into separate color planes, wherein each color plane corresponds to that portion of the final image that is applied to the substrate with a specific toner;
(c) separating each color plane that corresponds to a reduced density toner into at least two additional color planes, wherein each additional color plane corresponds to a different level of color in the final image;
(d) forming an electrostatic image comprising a pattern of dots on the substrate that corresponds to one of a color plane or an additional color plane;
(e) developing the electrostatic image with the appropriate color toner; and
(f) repeating (d) and (e) for each color plane to form the final image.

9. The method of claim 8, further comprising applying the reduced density toner to the substrate in at least two passes of the substrate through the electrostatic printer, such that each application creates incrementally darker dots by applying dots of reduced density toner one on top of the other.

10. The method of claim 8, further comprising creating the digital image on a computer.

11. The method of claim 10, further comprising creating the digital image by scanning an image with a digital scanner.

12. The method of claim 8, further comprising separating the image into the color planes with a raster image processing program.

13. The method of claim 1, further comprising selecting the set of toners from those sets comprising at least one cyan toner, at least one magenta toner, and at least one yellow toner.

14. The method of claim 13, further comprising selecting the toner set from the group consisting of
a set comprising black, reduced density cyan, dark magenta, and yellow;
a set comprising black, dark cyan, reduced density magenta, and yellow;
a set comprising black, reduced density cyan, reduced density magenta, and yellow;
a set comprising black, reduced density cyan, reduced density magenta, dark magenta, and yellow,
a set comprising black, reduced density cyan, dark cyan, reduced density magenta, and yellow;
a set comprising black, reduced density cyan, reduced density magenta, yellow, and a spot color;
a set comprising black, reduced density cyan, dark cyan, reduced density magenta, dark magenta, and yellow;
a set comprising black, reduced density cyan, reduced density magenta, dark magenta, yellow, and a spot color;
a set comprising black, reduced density cyan, dark cyan, reduced density magenta, yellow, and a spot color;
a set comprising black, reduced density cyan, dark cyan, reduced density magenta, yellow, and reduced density yellow; and
a set comprising black, reduced density cyan, reduced density magenta, dark magenta, yellow, and reduced density yellow.

15. The method of claim 1, further comprising independently providing at least two toners, having the same color, but different color densities, to one toner fountain, thereby allowing the toner fountain to function in the manner of a plurality of toner fountains.

16. The method of claim 1, further comprising using dye sublimation toners to develop the image, and transferring the developed image to a second substrate.

17. The method of claim 16, further comprising placing the image on the substrate in contact with the second substrate, and applying heat to transfer the image to the second substrate.

18. The method of claim 1, further comprising using reflective toners to develop the image.

19. A method of producing a high resolution image on an electrostatic printer, the method comprising:
(a) providing an electrostatic printer having a plurality of toner fountains and a set of liquid toners, the set selected from the group consisting of
a set comprising black, reduced density cyan, dark magenta, and yellow;
a set comprising black, dark cyan, reduced density magenta, and yellow;
a set comprising black, reduced density cyan, reduced density magenta, and yellow;
a set comprising black, reduced density cyan, reduced density magenta, dark magenta, and yellow,
a set comprising black, reduced density cyan, dark cyan, reduced density magenta, and yellow;
a set comprising black, reduced density cyan, reduced density magenta, yellow, and a spot color;
a set comprising black, dark cyan, dark magenta, yellow, and white;
a set comprising black, reduced density cyan, dark cyan, reduced density magenta, dark magenta, and yellow;
a set comprising black, reduced density cyan, reduced density magenta, dark magenta, yellow, and a spot color;
a set comprising black, reduced density cyan, dark cyan, reduced density magenta, yellow, and a spot color;
a set comprising black, reduced density cyan, dark cyan, reduced density magenta, yellow, and reduced density yellow; and
a set comprising black, reduced density cyan, reduced density magenta, dark magenta, yellow, and reduced density yellow;
(b) forming an electrostatic image on a substrate that corresponds to at least a portion of that portion of a final image that is formed from one of the toner colors;
(c) developing the electrostatic image with the appropriate color toner;
(d) forming the final image by repeating (b) and (c) for each color toner, and
(e) applying any of the reduced density toners and the white toner in at least two passes of a substrate through the electrostatic printer to develop the image for that color.

20. The method of claim 19, further comprising independently providing at least two toners of the same color, but different color density, to one toner fountain, thereby allowing the toner fountain to function in the manner of a plurality of toner fountains.

21. The method of claim 19, further comprising using dye sublimation toners to develop the image, and transferring the developed image to a second substrate.

22. The method of claim 21, further comprising placing the image on the substrate in contact with the second substrate, and applying heat to transfer the image to the second substrate.

23. The method of claim 19, further comprising using reflective toners to develop the image.

24. A method of producing a high resolution image on a substrate using an electrostatic printer, the method comprising:
(a) providing an electrostatic printer having a plurality of toner fountains and a set of liquid color toners, the set comprising at least one cyan toner, at least one magenta toner, and at least one yellow toner, wherein
at least one of the toners in the set is a reduced density toner having a color density less than that of a standard toner of the same color;
(b) creating a digital image that corresponds to a final image to be printed on a substrate;
(c) either separating the image into separate color planes, wherein each color plane is different, and corresponds to at least a portion of that portion of the final image that is applied to the substrate with a specific toner in a single pass of the substrate through the electrostatic printer;
or separating the image into separate color planes, wherein each color plane corresponds to that portion of the final image that is applied to the substrate with a specific toner, and separating each color plane that corresponds to a reduced density toner into at least two additional color planes, wherein each additional color plane corresponds to a different level of color in the final image;
(d) forming an electrostatic image on the substrate that corresponds to one of a color plane or an additional color plane, and developing the electrostatic image with the appropriate color toner;
(e) repeating (d) at least once for each color toner to form the final image; and
(f) applying the reduced density toner in at least two passes through the electrostatic printer to develop a desired image for that color.

25. The method of claim 24, further comprising forming a portion of the final image having a color density that is greater than that obtained with a single application pass of the reduced density toner by applying the reduced density toner to that portion of the image in multiple application passes.

26. The method of claim 24, further comprising creating the digital image on a computer, and separating the image into the color planes using a raster image processing program.

27. A developed electrostatic image on a substrate, the image comprising at least two layers of at least one reduced density toner having a color density less than that of a standard toner of the same color or a white toner.

28. The developed electrostatic image of claim 27, wherein the image comprises layers formed from a toner set selected from the group consisting of:
a set comprising black, reduced density cyan, dark magenta, and yellow;
a set comprising black, dark cyan, reduced density magenta, and yellow;
a set comprising black, reduced density cyan, reduced density magenta, and yellow;
a set comprising black, reduced density cyan, reduced density magenta, dark magenta, and yellow,
a set comprising black, reduced density cyan, dark cyan, reduced density magenta, and yellow;
a set comprising black, reduced density cyan, reduced density magenta, yellow, and a spot color;
a set comprising black, dark cyan, dark magenta, yellow, and white;
a set comprising black, reduced density cyan, dark cyan, reduced density magenta, dark magenta, and yellow;
a set comprising black, reduced density cyan, reduced density magenta, dark magenta, yellow, and a spot color;
a set comprising black, reduced density cyan, dark cyan, reduced density magenta, yellow, and a spot color;
a set comprising black, reduced density cyan, dark cyan, reduced density magenta, yellow, and reduced density yellow; and
a set comprising black, reduced density cyan, reduced density magenta, dark magenta, yellow, and reduced density yellow.
